(19) United States
(12) Patent Application Publication
(10) Pub. No.: US 2009/0211492 A1
(43) Pub. Date: Aug. 27, 2009

(54) Composition for thinning of oil-based paint

(76) Inventors: Charles L. Hawes, Cordova, TN (US); Dennis E. Shireman, Marion, AR (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(21) Appl. No.: 12/383,319

(22) Filed: Mar. 23, 2009

Related U.S. Application Data
(63) Continuation-in-part of application No. 11/299,070, filed on Dec. 10, 2005, now abandoned.

(51) Int. Cl. B41M 5/165; C08L 83/06

(52) U.S. Cl. 106/311; 524/588

(57) ABSTRACT

A composition and related process for thinning oil-based paint, wherein the composition is a solvent external emulsion and comprises a hydrocarbon solvent, a surfactant and water.

### REFERENCE TO RELATED APPLICATION

This application is a continuation-in-part of, and claims the benefit of, U.S. patent application Ser. No. 11/299,070, filed Dec. 10, 2005.

### TECHNICAL FIELD

The present invention relates to a composition for thinning oil-based paint. In a more specific aspect, this invention relates to a paint thinning composition for oil-based paint in which the composition is in the form of an emulsion. This invention also relates to a process for thinning oil-based paint.

In this application, the term “paint” will be understood to refer to oil-based coatings such as epoxies, enamels, primers, basecoats, varnishes and polyurethane finishes, such coatings being used to protect and/or beautify substrates. As used in this application, the term “paint thinning”, “paint thinner” and similar terms refer to compositions and processes which reduce the viscosity of oil-based paint by adding the paint thinner to an oil-based paint and then stirring this mixture before applying the thinned paint to a substrate.

In this application, the term “emulsion” will be understood to refer to a suspension of small globules or droplets of a liquid in a second liquid in which the globules are not soluble. The emulsion of this application is a macroemulsion and can be described as solvent external, in which the liquid globules (sometimes referred to as the internal phase) are suspended in a second or surrounding liquid (sometimes referred to as the external phase).

### BACKGROUND OF THE INVENTION

Compositions for paint thinning are well-known in the industry, and many types of compositions exist for these particular uses.

Mineral spirits, a hydrocarbon solvent derived from crude oil, is perhaps the most commonly used paint thinner, especially for oil-based paint. Mineral spirits is also commonly used in paint cleanup for the tools and other surfaces used in painting with oil-based paint. Because of its direct relation to crude oil, mineral spirits is subject to fluctuations in the price of crude oil, such fluctuations often being upward.

Additionally, as local, state and federal governments require stricter controls on the amount of volatile organic compounds and combustible chemicals which can be used, the compositions used to thin paint often must be changed to comply with those controls.

Another commonly used paint thinner is turpentine. However, in contrast to turpentine, mineral spirits leaves no gummy residue, does not tend to deteriorate with age and is generally less expensive.

However, paint thinner compositions which are predominantly or entirely composed of mineral spirits or turpentine may create safety concerns, as these two materials are highly combustible.

Biodegradability may also be a concern for current paint thinner compositions which are predominantly or entirely composed of mineral spirits.

In addition, when working with paint thinner compositions, the user must also be concerned about the disposal of hazardous substances and the use of non-renewable resources. These two concerns are becoming more important as environmental issues become more significant.

The prior art contains many disclosures of compositions and methods which can be used to reduce the viscosity of certain compositions. For example, Bostrom et al. U.S. Pat. No. 6,150,445 discloses a composition and method for use in reducing the viscosity of an aqueous concentrate.

Sau U.S. Pat. No. 6,900,255 discloses a composition and method for suppressing (i.e., reducing) the viscosity in film forming coatings, such as latex paints.

In addition to disclosures in regard to viscosity reduction, the prior art discloses the use of emulsions in various industries. For example, Mulqueen et al. U.S. Pat. No. 6,074,986 discloses a composition and method for the preparation of emulsions in the cosmetic, pharmaceutical, food, photographic, paint and polymer industries.

Another disadvantage or undesirable result with prior art paint thinners is their tendency to adversely affect the physical or chemical properties of the paint, which can be evident before the thinned paint is applied to a substrate or after the thinned paint is applied to a substrate, both during the curing stage of the thinned paint and after the thinned paint is fully cured.

Thus, for various reasons, the paint thinner compositions of the prior art do not achieve the desired results in many situations.

Therefore, there is a need in the industry for a paint thinner composition for oil-based paint in which the composition eliminates or minimizes the disadvantages or problems encountered with the prior art compositions.

### SUMMARY OF THE INVENTION

The present invention provides an improved composition for thinning oil-based paint. As compared to the compositions of the prior art as described above, the composition of this invention is cost effective, contains less volatile organic compounds, does not adversely affect the physical or chemical properties of the thinned paint and reduces concerns in regard to safety, hazardous waste disposal and renewal of resources.

The present invention also provides a process for thinning oil-based paint.

Briefly described, the present invention provides a new and improved composition which is a solvent external emulsion and which contains a hydrocarbon solvent, a surfactant and water. Each component is used in a defined weight percent range, based on the total weight of the composition.

The present invention describes the formulation of a solvent external emulsion composition for thinning oil-based paint. In this composition, the hydrocarbon solvent component is the external phase, and the water component is the internal phase present as very small droplets dispersed in the hydrocarbon solvent component. The surfactant component of this composition is present at the interface of the external and internal phases.

Use of a solvent external composition has certain advantages over other types of emulsions, specifically in regard to the thinning and cleanup of oil-based paint. The present solvent external composition will incoroporate into the oil-based paint much easier than other types of emulsions. Thus, the emulsion of this invention requires less mixing and means less chance of a phase inversion to occur which can damage the liquid form of the paint and even cause the paint to be unusuable.

Another advantage is that the solvent external emulsion of this invention provides better performance in the cleanup aspect of a paint thinner. The hydrocarbon solvent (external phase) has better and quicker access to the paint being cleaned off a tool or surface in the cleanup process of painting.

Accordingly, an object of this invention is to provide a composition for thinning oil-based paint.

Another object of this invention is to provide a paint thinner composition for thinning oil-based paint in which the composition contains a low amount of volatile organic compounds.

Another object of this invention is to provide a paint thinner composition for thinning oil-based paint in which the composition provides less fuel to burn.

Another object of this invention is to provide a paint thinner composition for thinning oil-based paint in which the composition provides less hazardous waste for disposal.

Another object of this invention is to provide a paint thinner composition for thinning oil-based paint in which the composition does not adversely affect the physical or chemical properties of the uncured or cured thinned paint.

Another object of this invention is to provide a paint thinner composition for thinning oil-based paint in which the composition is a solvent external emulsion.

Still another object of this invention is to provide a process for thinning oil-based paint.

Still another object of this invention is to provide a process for thinning oil-based paint with a composition which is a solvent external emulsion.

These and other objects, features and advantages of the present invention will become apparent from the following description.

### DETAILED DESCRIPTION OF THE INVENTION

The present invention provides a composition in the form of a solvent external emulsion for thinning oil-based paint, wherein the composition comprises a hydrocarbon solvent, a surfactant and water. The present invention also provides a process by which the above-defined emulsion can be effectively used to thin oil-based paint.

As defined above, there are certain essential components in the composition of this invention. These components and their corresponding weight percent ranges are shown below, with the weight percents being based on the total weight of the composition.

| Component | Weight Percent Range |
|---|---|
| Hydrocarbon Solvent | about 16.0 to about 90.0 |
| | (preferably about 20.0 to about 65.0) |
| Surfactant | about 0.01 to about 10.0 |
| | (preferably about 0.05 to about 5.0) |
| Water | about 20.0 to about 85.0 |
| | (preferably about 45.0 to about 80.0) |

If these components are used in amounts outside these ranges, the composition may provide results which do not meet the user's objectives for thinning oil-based paint.

The work which lead to the present invention was begun with the knowledge that many hydrocarbon solvents (such as mineral spirits) are well known in the industry to reduce the viscosity of oil-based paint. Also well known in the industry is that oil-based paint cannot be thinned with water which, in most instances, will instead increase the viscosity of oil-based paint.

However, we have discovered that a hydrocarbon solvent can be combined with relatively large amounts of water to reduce the viscosity of oil-based paint when mixed with the paint. This is unexpected, because one would expect that using more water in the composition than hydrocarbon solvent would tend to result in either no reduction of the viscosity of an oil-based paint or an increase in the viscosity of an oil-based paint. We believe the unexpected results of this invention are due at least in part to the compositions being a solvent external emulsion.

Another unexpected result of the present invention is that the solvent external composition does not substantially adversely affect the physical or chemical properties of either the uncured or cured thinned oil-based paint.

Optional components may be added to the composition of this invention to achieve other objectives. Examples of these optional components are preservatives, colorants, evaporation retardants, humectants, anti-settling agents, pigments, bittering agents, pH adjusting agents, etc. These optional components can be used in the amounts necessary to achieve desired results.

The solvent external emulsion composition of this invention provides several advantages, a principal one being that the composition does not substantially adversely affect the physical or chemical properties of the paint. Examples of such properties are color, gloss, hardness, cure time, surface defects (such as wrinkles, pin holes and orange peels), durability (such as cracking, peeling and fading) and resistance to chemical attack.

In this invention, the hydrocarbon solvent contains from about 7 to about 18 carbon atoms and functions as the primary thinning component. Examples of suitable hydrocarbon solvents are aliphatic and aromatic hydrocarbons and mixtures of two or more of these solvents.

Examples of suitable aliphatic and aromatic hydrocarbon solvents include terpenes, pine terpenes, raffinate solvents (aliphatic and aromatic), mineral spirits, kerosene, naptha, xylene, petroleum distillates, mineral seal oil, heptane and its isomers, Stoddard solvents, Rule 66 solvents, toluene, methyl cyclohexane, linear octadecane and its isomers and alkene hydrocarbons. Examples of suitable terpene hydrocarbon solvents include d-limonene, dipentene and turpentine. The preferred hydrocarbon solvent is mineral spirits.

The surfactant functions as a stabilizer to produce the emulsion and then to prevent separation of the emulsion into various components. Examples of suitable surfactants are nonionic surfactants, anionic surfactants, cationic surfactants, amphoteric surfactants and mixtures of two or more of these surfactants. The surfactant or surfactant mixture should be mixable in the solvent or solvent mixture and have an average HLB less than 8 and preferably less than 5.

Examples of suitable nonionic surfactants are:
alkoxylated alkyl phenols;
alkoxylated alcohols;
amines;
amides;
alkoxylated amides;
alkoxylated amines;
alkoxylated fatty acids;
alkoxylated thioethers;
glycerol esters;
sorbitan and alkoxylated sorbitan esters;
polygluconates;
silicone surfactants;
polymeric nonionic surfactants; and
ethylene oxide/propylene oxide block copolymers.

Examples of suitable cationic surfactants are:
alkyl trimethylammonium chlorides and bromides having from 12 to 22 carbon atoms and alkoxylated derivatives thereof;
dialkyl dimethylammonium chlorides and bromides having from 12 to 22 carbon atoms and alkoxylated derivatives thereof;
alkyl amine hydrochlorides and hydrobromides;
sulfates and sulfonates having from 12 to 22 carbon atoms and alkoxylated derivates thereof.

Examples of suitable anionic surfactants are:
acids and salts of alkyl sulfates and alkyl ether sulfates having from 12 to 30 carbon atoms;
acids and salts of alkylbenzene sulfonates having from 12 to 30 carbon atoms;
acids and salts of alkyldiphenyl oxides, sulfonates and disulfonates having from 12 to 30 carbon atoms;
acids and salts of alkyl naphthalene sulfonates having from 12 to 30 carbon atoms;
acids and salts of alkane or olefin sulfonates having from 10 to 20 carbon atoms;
acids and salts of ester sulfonates having from 12 to 20 carbon atoms;
acids and salts or various half salts of alkyl sulfosuccinates;
acids and salts of sulfobetaines;
acids and salts of phosphate esters;
acids and salts of saturated and unsaturated fatty acids having from 10 to 24 carbon atoms;
acids and salts of taurates and isothionates having from 12 to 24 carbon atoms.

Example of suitable amphoteric surfactants are:
amine oxides and betaines having from 10 to 20 carbon atoms;
alkyl imidazolines and imidazoline derivatives having from 10 to 24 carbon atoms;
acids and salts of alkylpropionates having from 10 to 24 carbon atoms;
acids and salts of alpha and beta alkyl aminoacid derivatives having from 10 to 24 carbon atoms;
alkyl substituted nitrogen heterocyclics having from 10 to 24 carbon atoms.

The water used in the composition of this invention can be distilled, soft, hard, tap, potable and non-potable water. Mixtures of such waters can be used.

After adding the solvent external composition of this invention to an oil-based paint, this mixture is then stirred. (As used in this application, the terms “stirred” or “stirring” will be understood to refer to actual stirring, shaking, agitating, mixing or other mixing by mechanical means.)

The present invention is further illustrated by the following examples which are designed to teach those of ordinary skill in the art how to practice this invention and to represent the best mode contemplated for carrying out this invention.

### Procedure

The following solvent external emulsions were prepared using techniques and process steps which are well known in the industry, such as low, medium and high shear dispersing or homogenization. With the solvent external compositions of Examples 1-11, the hydrocarbon solvent and surfactant were mixed together, followed by the addition of water.

### EXAMPLE 1

| Component | Weight Percent |
|---|---|
| Mineral Spirits | 35.0 |
| Propylene Glycol | 1.0 |
| Tall Oil Fatty Acid | 0.375 |
| 5 Mole Ethoxylated Cocoamine | 0.5 |
| Water | 63.125 |
| | 100.00 |

### EXAMPLE 2

| Component | Weight Percent |
|---|---|
| Mineral Spirits | 35.0 |
| Hypermer 2234* | 1.0 |
| Water | 64.00 |
| | 100.00 |

*a polymeric nonionic surfactant available from Croda Corp., Edison, New Jersey

### EXAMPLE 3

| Component | Weight Percent |
|---|---|
| Mineral Spirits | 35.0 |
| Tall Oil Fatty Acid | 0.5 |
| 5 Mole Ethoxylated Cocoamine | 0.375 |
| Propylene Glycol | 1.0 |
| Sodium Chloride | 0.25 |
| Water | 62.875 |
| | 100.00 |

### EXAMPLE 4

| Component | Weight Percent |
|---|---|
| Aromatic 150 Solvent* | 35.0 |
| Tall Oil Fatty Acid | 0.375 |
| 5 Mole Ethoxylated Cocoamine | 0.5 |
| Propylene Glycol | 1.0 |
| Sodium Chloride | 0.25 |
| Water | 62.875 |
| | 100.00 |

*a mixture of alkyl benzenes available from Exxon Mobil Corp., Houston, Texas

### EXAMPLE 5

| Component | Weight Percent |
|---|---|
| d-Limonene | 35.0 |
| 5 Mole Ethoxylated Cocoamine | 0.46 |
| Tall Oil Fatty Acid | 0.375 |
| Water | 64.165 |
| | 100.00 |

### EXAMPLE 6

| Component | Weight Percent |
|---|---|
| Mineral Spirits | 35.0 |
| Oleic Acid Amide | 0.75 |
| Water | 64.25 |
| | 100.00 |

### EXAMPLE 7

| Component | Weight Percent |
|---|---|
| Mineral Spirits | 50.0 |
| Tall Oil Fatty Acid | 0.375 |
| 5 Mole Ethoxylated Cocoamine | 0.5 |
| Water | 49.125 |
| | 100.00 |

### EXAMPLE 8

| Component | Weight Percent |
|---|---|
| Mineral Spirits | 35.0 |
| Dodecylbenzene Sulfonic Acid | 0.5 |
| Sodium Chloride | 0.25 |
| Dodecyldimethylamine | 0.375 |
| Water | 63.875 |
| | 100.00 |

### EXAMPLE 9

| Component | Weight Percent |
|---|---|
| Mineral Spirits | 35.0 |
| Silsurf J208-812* | 0.75 |
| Water | 64.25 |
| | 100.00 |

*a silicone glycol copolymer surfactant available from Sil Tech, LLC, Dacula, Georgia

### EXAMPLE 10

| Component | Weight Percent |
|---|---|
| Mineral Spirits | 35.0 |
| Oleyl Hydroxyethylimidazoline | 0.75 |
| Water | 64.25 |
| | 100.00 |

### EXAMPLE 11

| Component | Weight Percent |
|---|---|
| Mineral Spirits | 20.0 |
| Oleyl Hydroxyethylimidazoline | 0.75 |
| Water | 79.25 |
| | 100.00 |

These compositions were tested for their ability to thin uncured oil-based paint. Each composition provided good results, as shown below.

Thinning tests were conducted on GLIDDEN Ultra Hide oil/alkyd/semi gloss interior/exterior uncured paint using a Ford #4 Testing Cup (by the ASTM D1200-94 method for viscosity), and results were expressed in time in seconds to drain through the Cup.
Paint Only=446 seconds
Example 1=215 seconds
Example 2=188 seconds
Example 3=183 seconds
Example 4=148 seconds
Example 5=183 seconds
Example 6=193 seconds
Example 7=134 seconds
Example 8=185 seconds
Example 9=212 seconds
Example 10=227 seconds
Example 11=285 seconds

The composition of Example 10 was used to thin the commercially available oil-based paints identified below, and the thinned paints were then tested for gloss retention. The results show that these thinned paints had a gloss retention which is either improved or at least equivalent to the gloss retention when these same paints were thinned with the same amount of mineral spirits. The results show the GARDNER Micro Tri Gloss 60° readings after the thinned paints were allowed to dry.

| Oil-Based Paint | 10% Mineral Spirits | 10% Example 10 |
|---|---|---|
| (Uncured) | (90% Paint) | (90% Paint) |
| FARRELL Calhoun | 89.77 | 88.56 |
| Ford blue | | |
| GLIDDEN Ultra Hide | 87.13 | 90.6 |
| crimson red | | |
| GLIDDEN Ultra Hide | 74.63 | 78.43 |
| green | | |
| SHERWIN WILLIAMS | 73.23 | 78.23 |
| Enamel green | | |
| SHERWIN WILLIAMS | 83.13 | 85.8 |
| Enamel safety red | | |

The results show that the solvent external emulsion composition of this invention is highly effective in thinning uncured oil-based alkyd paints.

By using less solvent than conventional paint thinning compositions, the solvent external compositions of this invention provide several advantages when compared to such conventional compositions:
In regard to safety - - - furnishes less fuel to burn if a fire should occur; and
In regard to disposal - - - provides less hazardous waste for disposal.

The solvent external emulsion composition of this invention provides many other advantages and/or properties when compared to prior art thinning compositions. Examples of such advantages and/or properties include:
(a) The composition of this invention does not substantially adversely (or negatively) affect the quality of the thinned oil-based paint before that paint is applied to a substrate, such as by increasing the viscosity, causing flocculation of the paint or decreasing shelf stability.
(b) The chemical or physical properties of cured oil-based paint are not substantially adversely affected by thinning with the composition of this invention. Examples of such properties include:
   1. Pencil Hardness, as measured by the ASTM D 3363-05 method, is not affected by more than 2 units.
   The Pencil Hardness test has been used for many years in the industry to determine the hardness of clear and pigmented organic coatings. This test has also been used in the industry to determine the cure of these coatings, especially when these coatings are forced dried using heat.
   2. Durability (for example, dry abrasion mar resistance as measured by the ASTM D 6037-96 method).
   3. Gloss, as measured by the ASTM D 523-08 method, is not affected by more than 10 units.
   4. Color, as measured by the ASTM D 523-08 method.
   5. Resistance to Chemical Attack, as measured by the ASTM D 5402-06 method.

The present invention has been described in detail with particular reference to certain embodiments, but variations and modifications can be made without departing from the spirit and scope of the invention as defined in the following claims.

What is claimed is:

1. A solvent external emulsion composition for thinning oil-based paint, wherein the composition comprises:
A. from about 16.0 to about 90.0 percent by weight of a hydrocarbon solvent;
B. from about 0.01 to about 10.0 percent by weight of a surfactant; and
C. from about 20.0 to about 75.0 percent by weight of water.

2. A composition as defined by claim 1 wherein the hydrocarbon solvent is an aliphatic hydrocarbon, aromatic hydrocarbon or a mixture of two or more of these solvents.

3. A composition as defined by claim 1 wherein the hydrocarbon solvent is mineral spirits, kerosene, naptha, xylene, mineral seal oil, a terpene or a petroleum distillate.

4. A composition as defined by claim 1 wherein the hydrocarbon solvent is d-limonene.

5. A composition as defined by claim 1 wherein the hydrocarbon solvent is mineral spirits.

6. A composition as defined by claim 1 wherein the surfactant is a nonionic, anionic, cationic or amphoteric surfactant or a mixture of two or more of these surfactants.

7. A composition as defined by claim 1 wherein the surfactant is a mixture of tall oil fatty acid and 5 mole ethoxylated cocoamine.

8. A composition as defined by claim 1 wherein the surfactant is a polymeric nonionic surfactant.

9. A composition as defined by claim 1 wherein the surfactant is oleic acid amide.

10. A composition as defined by claim 1 wherein the surfactant is oleyl hydroxyethylimidazoline.

11. A composition as defined by claim 1 wherein the surfactant is a mixture of dodecydimethylamine and dodecylbenzene sulfonic acid.

12. A composition as defined by claim 1 wherein the water is distilled, soft, hard, tap, potable or non-potable water.

13. A process for thinning oil-based paint, wherein the process comprises mixing uncured oil-based paint and a solvent external emulsion composition which comprises:
A. from about 16.0 to about 90.0 percent by weight of a hydrocarbon solvent;
B. from about 0.01 to about 10.0 percent by weight of a surfactant; and
C. from about 20.0 to about 75.0 percent by weight of water;
and then stirring the mixture.

14. A process as defined by claim 13 wherein the hydrocarbon solvent is an aliphatic hydrocarbon, aromatic hydrocarbon or a mixture of two or more of these solvents.

15. A process as defined by claim 13 wherein the hydrocarbon solvent is mineral spirits, kerosene, naptha, xylene, mineral seal oil, a terpene or a petroleum distillate.

16. A process as defined by claim 13 wherein the hydrocarbon solvent is d-limonene.

17. A process as defined by claim 13 wherein the hydrocarbon solvent is mineral spirits.

18. A process as defined by claim 13 wherein the surfactant is a nonionic, anionic, cationic or amphoteric surfactant or a mixture of two or more of these surfactants.

19. A process as defined by claim 13 wherein the surfactant is a mixture of tall oil fatty acid and 5 mole ethoxylated cocoamine.

20. A process as defined by claim 13 wherein the surfactant is a polymeric nonionic surfactant.

21. A process as defined by claim 13 wherein the surfactant is oleic acid amide.

22. A process as defined by claim 13 wherein the surfactant is oleyl hydroxyethylimidazoline.

23. A process as defined by claim 13 wherein the surfactant is a mixture of dodecydimethylamine and dodecylbenzene sulfonic acid.

24. A process as defined by claim 13 wherein the water is distilled, soft, hard, tap, potable or non-potable water.
